(19) United States
(12) Patent Application Publication
(10) Pub. No.: US 2024/0046267 A1
(43) Pub. Date: Feb. 8, 2024

(54) Virtual Blockchain Applications for Stored Value Tokens

(71) Applicant: Bluestack Systems, Inc., Campbell, CA (US)

(72) Inventor: Sohil Arora, Haryana (IN)

(73) Assignee: Bluestack Systems, Inc., Campbell, CA (US)

(21) Appl. No.: 18/231,426

(22) Filed: Aug. 8, 2023

Related U.S. Application Data
(60) Provisional application No. 63/395,967, filed on Aug. 8, 2022.

(51) Int. Cl. G06Q 20/40; G06Q 20/38; G06Q 20/36

(52) U.S. Cl. CPC G06Q 20/401; G06Q 20/389; G06Q 20/367

(57) ABSTRACT

The invention provides solutions for generating, provisioning or transferring non-fungible tokens through a stored value token that has an associated stored value, and that additionally has an associated entitlement to a non-fungible token (which non-fungible token is unrelated to or distinct from the stored value). The invention additionally provides mechanisms wherein the entitlement to a non-fungible token that is associated with a stored value token can be claimed, resulting in a non-fungible token being generated, provisioned or transferred to a beneficiary of the stored value token.

### CROSS-REFERENCE TO RELATED APPLICATION

This application claims priority to U.S. Provisional Patent Application No. 63/395,967 filed Aug. 8, 2022, the disclosure of which is hereby incorporated by reference in its entirety.

### BACKGROUND OF THE INVENTION

### Field of the Invention

The present invention relates to provisioning of non-fungible tokens. In particular, the present invention provides methods, systems and computer program products for provisioning or transfer of non-fungible tokens to a beneficiary of a stored value token.

### Description of Related Art

Blockchain technology is increasingly used for implementing digital assets, that have been generated in the form of non-fungible tokens (or NFTs). Non-fungible tokens are generally different from other digital tokens or currencies. Non-fungible tokens are tokenized versions of digital or real-world assets. They can function as verifiable proofs of authenticity and ownership within a blockchain network.

In general, non-fungible tokens are not interchangeable with each other and may be understood as implementing rights management solutions within the digital domain. While non-fungible tokens can be bought or sold using fungible tokens such as digital currency or non-digital currency, non-fungible tokens themselves comprise a unique asset class and are not substitutable like fungible tokens. Identifying information is embedded in each non-fungible token's smart contract, making each non-fungible token unique. This uniqueness makes non-fungible tokens unsuitable for conventional crypto trading purposes and token currency exchanges but ideal for recording and storing the ownership of digital items like collectibles, games and even art. For example, FIG. 1 illustrates a non-fungible token comprising a screenshot of an artwork image of a type that could be part of a cloud based computer game.

However, generating non-fungible tokens and securely buying or selling such non-fungible tokens remains complex—and therefore out of the reach of the average user of computer devices and software services.

There is accordingly a need for popularizing non-fungible tokens and for providing distribution mechanisms and distribution channels for enabling non-fungible tokens to be generated, provisioned or transferred without requiring particularized expertise.

### SUMMARY OF THE INVENTION

The invention provides solutions for generating, provisioning or transferring non-fungible tokens through a stored value token that has an associated stored value, and that additionally has an associated entitlement to a non-fungible token (which non-fungible token is unrelated to or distinct from the stored value). The invention additionally provides mechanisms wherein the entitlement to a non-fungible token that is associated with a stored value token can be claimed, resulting in a non-fungible token being generated, provisioned or transferred to a beneficiary of the stored value token.

The invention provides a method for obtaining to a beneficiary, rights in a non-fungible token (NFT) that is recorded within a distributed blockchain ledger, based on acquisition of a stored value token. the method comprises implementing at a NFT service platform server, the steps of (i) receiving a data input transmitted from a client terminal, wherein the data input identifies a unique identifier corresponding to a stored value token, (ii) identifying within a database of stored value token data records, a data record associated with the stored value token that corresponds to the unique identifier, (iii) extracting from the identified data record, data representing a set of non-fungible token parameters associated with the stored value token, (iv) generating or retrieving a NFT having one or more non-fungible token parameters that match non-fungible token parameters represented by the data extracted from the identified data record, (v) initiating a NFT transfer process for transferring rights in the NFT to an identified beneficiary, wherein (a) the NFT transfer process includes selectively transferring the NFT to one of (1) a crypto-wallet associated with the identified beneficiary, and (2) an administrator account, and (b) responsive to transfer of the NFT to the crypto-wallet associated with the identified beneficiary, recording data representing the identified beneficiary's right(s) in the NFT in a record block within a distributed blockchain ledger on which the NFT is stored.

In an embodiment of the method, the NFT transfer process comprises responding to a determination that a crypto-wallet address of the identified beneficiary is available, by transferring the NFT to a crypto-wallet identified by the crypto-wallet address.

In another embodiment of the method, the NFT transfer process comprises responding to a determination that a crypto-wallet address of the identified beneficiary is unavailable, by (i) transferring the NFT to the administrator account, and (ii) recording at the administrator account, an association between the NFT and a unique identifier associated with the identified beneficiary.

In a further embodiment, the method comprises (i) identifying based on a received user id, a set of NFTs stored in the administrator account, wherein the received user id comprises an identifier uniquely associated with the beneficiary in the records of the administrator account, (ii) transferring one or more NFTs within the identified set of NFTs from the beneficiary to a transferee crypto-wallet associated with a specified transferee, and (iii) responsive to transfer of the one or more NFTs to the transferee crypto-wallet, recording data representing the transferee's right(s) in the transferred one or more NFTs in one or more record block within a distributed blockchain ledger on which said one or more NFTs are stored.

In a method embodiment, the stored value token comprises any physical token or electronic token or virtual token that has one or more unique identifier(s) associated therewith, and that has a stored value account linked thereto, wherein said stored value account is configured to enable recordal or storage of any of currency value, rewards points, or gift coupon points.

In another embodiment of the method, the identified beneficiary (i) is an entity that is associated with the stored value token, or that has ownership or possession of the stored value token, or (ii) has been identified based on a data instruction received from an entity that is associated with the stored value token, or that has ownership or possession of the stored value token;

In a particular embodiment of the method, the data representing the identified beneficiary's right(s) in the NFT in the record block within the distributed blockchain ledger on which the NFT is stored, is associated with the stored NFT.

The invention also provides a system configured for obtaining to a beneficiary, rights in a non-fungible token (NFT) that is recorded within a distributed blockchain ledger, based on acquisition of a stored value token. The system comprises a processor implemented NFT service platform server configured to implement the steps of (i) receiving a data input transmitted from a client terminal, wherein the data input identifies a unique identifier corresponding to a stored value token, (ii) identifying within a database of stored value token data records, a data record associated with the stored value token that corresponds to the unique identifier, (iii) extracting from the identified data record, data representing a set of non-fungible token parameters associated with the stored value token, (iv) generating or retrieving a NFT having one or more non-fungible token parameters that match non-fungible token parameters represented by the data extracted from the identified data record, (v) initiating a NFT transfer process for transferring rights in the NFT to an identified beneficiary, wherein (a) the NFT transfer process includes selectively transferring the NFT to one of (1) a crypto-wallet associated with the identified beneficiary, and (2) an administrator account, and (b) responsive to transfer of the NFT to the crypto-wallet associated with the identified beneficiary, recording data representing the identified beneficiary's right(s) in the NFT in a record block within a distributed blockchain ledger on which the NFT is stored.

In an embodiment the system is configured such that implementing the NFT transfer process comprises responding to a determination that a crypto-wallet address of the identified beneficiary is available, by transferring the NFT to a crypto-wallet identified by the crypto-wallet address.

The system may in a particular embodiment be configured such that implementing the NFT transfer process comprises responding to a determination that a crypto-wallet address of the identified beneficiary is unavailable, by (i) transferring the NFT to the administrator account, and (ii) recording at the administrator account, an association between the NFT and a unique identifier associated with the identified beneficiary.

The system may further configured be for (i) identifying based on a received user id, a set of NFTs stored in the administrator account, wherein the received user id comprises an identifier uniquely associated with the beneficiary in the records of the administrator account, (ii) transferring one or more NFTs within the identified set of NFTs from the beneficiary to a transferee crypto-wallet associated with a specified transferee, and (iii) responsive to transfer of the one or more NFTs to the transferee crypto-wallet, recording data representing the transferee's right(s) in the transferred one or more NFTs in one or more record block within a distributed blockchain ledger on which said one or more NFTs are stored.

In a particular embodiment, the system is configured such that the stored value token comprises any physical token or electronic token or virtual token that has one or more unique identifier(s) associated therewith, and has a stored value account linked thereto, wherein said stored value account is configured to enable recordal or storage of any of currency value, rewards points, or gift coupon points.

In a system embodiment, the identified beneficiary (i) is an entity that is associated with the stored value token, or that has ownership or possession of the stored value token, or (ii) has been identified based on a data instruction received from an entity that is associated with the stored value token, or that has ownership or possession of the stored value token;

In another system embodiment, the data representing the identified beneficiary's right(s) in the NFT in the record block within the distributed blockchain ledger on which the NFT is stored, is associated with the stored NFT.

The invention also provides a computer program product for obtaining to a beneficiary, rights in a non-fungible token (NFT) that is recorded within a distributed blockchain ledger, based on acquisition of a stored value token. The computer program product comprises a non-transitory computer readable medium having a computer readable program code embodied therein. The computer readable program code comprises instructions for implementing the steps of (i) receiving a data input transmitted from a client terminal, wherein the data input identifies a unique identifier corresponding to a stored value token, (ii) identifying within a database of stored value token data records, a data record associated with the stored value token that corresponds to the unique identifier, (iii) extracting from the identified data record, data representing a set of non-fungible token parameters associated with the stored value token, (iv) generating or retrieving a NFT having one or more non-fungible token parameters that match non-fungible token parameters represented by the data extracted from the identified data record, (v) initiating a NFT transfer process for transferring rights in the NFT to an identified beneficiary, wherein (a) the NFT transfer process includes selectively transferring the NFT to one of (1) a crypto-wallet associated with the identified beneficiary, and (2) an administrator account, and (b) responsive to transfer of the NFT to the crypto-wallet associated with the identified beneficiary, recording data representing the identified beneficiary's right(s) in the NFT in a record block within a distributed blockchain ledger on which the NFT is stored.

In more specific embodiments, the computer program product is configured to implement any one of more steps of the methods of the invention as are described throughout this specification.

### BRIEF DESCRIPTION OF THE DRAWINGS

FIG. 1 illustrates an exemplary non-fungible token.

FIG. 2 illustrates a system environment of a kind that may be used to implement the teachings of the present invention.

FIG. 3 illustrates an exemplary configuration for a system configured to enable generating, provisioning or transferring non-fungible tokens through a stored value token, in accordance with the teachings of the present invention.

FIGS. 4A and 4B are flowcharts illustrating method steps involved in generating a stored value token that has both an associated stored value, and an associated entitlement to a non-fungible token.

FIG. 5 is a flowchart illustrating method steps involved in generating, provisioning or transferring non-fungible tokens through a stored value token, in accordance with the teachings of the present invention.

FIG. 6 is a communication flow diagram illustrating communication flow between system entities for implementing the method of FIG. 5.

FIG. 7 is a flowchart illustrating method steps involved in assigning or provisioning to a beneficiary of a stored value token, a non-fungible token corresponding to an entitlement to a non-fungible token that is associated with the stored value token.

FIG. 8 is a flowchart illustrating method steps involved in access and management of non-fungible tokens through a non-fungible token management portal.

FIG. 9 illustrates an exemplary system for implementing the present invention.

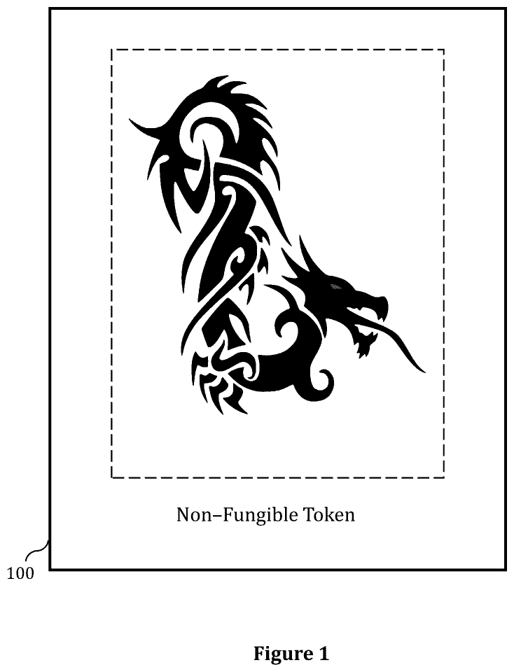

### DESCRIPTION OF THE INVENTION

The invention provides solutions for generating provisioning or transferring non-fungible tokens through a stored value token that has an associated stored value, and that additionally has an associated entitlement to a non-fungible token (which non-fungible token is unrelated to or distinct from the stored value), wherein the stored value token(s). The invention additionally provides mechanisms wherein the entitlement to a non-fungible token that is associated with a stored value token can be claimed, resulting in a non-fungible token being generated, provisioned or transferred to a beneficiary of the stored value token.

For the purposes of the present invention, the term “stored value token” shall mean any physical or electronic token or virtual token that has one or more unique identifier(s) associated therewith, and which have a stored value account linked thereto—so that one or more forms of value, such as currency value, rewards points, gift coupon points etc. can be stored in the stored value account associated with said physical or electronic or virtual token. Non-limiting examples of stored value tokens include pre-paid currency cards, gift cards, loyalty reward cards or loyalty point accounts, scratch cards, or even a unique identifier that uniquely links to a stored value account.

The invention involves associating a stored value token with a non-fungible token, or with an entitlement to receive a non-fungible token, such that presentation of an identifier associated with the stored value token enables identification of the non-fungible token, or the entitlement to receive a non-fungible token, that is linked with the stored value account. In the event the stored value token is linked with a non-fungible token, the identified non-fungible token can be provisioned or transferred to a beneficiary of the stored value token (e.g. the purchaser of the stored value token or a person to whom the stored value token has been gifted). In the event the stored value token is linked with an entitlement to a non-fungible token, a non-fungible token can be generated and thereafter provisioned or transferred to a beneficiary of the stored value token (e.g. the purchaser of the stored value token or a person to whom the stored value token has been gifted). In an embodiment where a non-fungible token is generated in response to determining that the stored value token is linked with an entitlement to a non-fungible token, the step of generating the non-fungible token comprises (i) generating a non-fungible token record representing the non-fungible token, wherein the non-fungible token record includes data identifying or representing selected content (for example media content) recorded within the non-fungible token, and (ii) implementing recordal of the non-fungible token on a distributed blockchain ledger, wherein implementing the recordal comprises (a) transmitting the non-fungible token record to a non-fungible token services platform, and (b) storing data from the non-fungible token record in a record block associated with the distributed blockchain ledger.

The non-fungible token (or entitlement to a non-fungible token) linked to the stored value token is distinct from (and in addition to) the stored value (e.g. a currency value or gift card value) that is stored in the stored value account. Accordingly the non-fungible token or entitlement to the non-fungible token comprises an “additional” benefit associated with the stored value token.

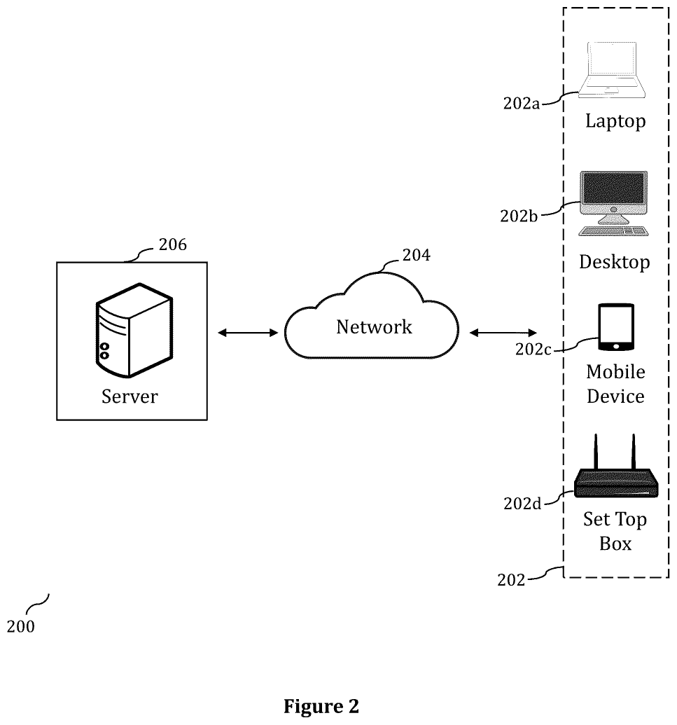

The methods of the present invention may be implemented within a system environment 200 of a kind illustrated in FIG. 2. System environment 200 comprises one or more client devices 202 (for example, any of laptop 202a, desktop 202b, mobile device 202c and/or set top box 202d) interfacing through network 204, with a server 206. The server 206 may be configured to support a conventional server-client arrangement, where the client device 202 may communicate with server 206 for any one or more of several purposes, including for example downloading a software application, configuring the downloaded software application, updating the downloaded software application, or enabling client device 202 to upload or download data.

Alternatively, server 206 may be configured to provide cloud based service(s) to a requesting client device 202, wherein a software application required by client device 202 is installed and run on server 206, and video and audio output data from the software application is streamed to and rendered on client device 202. The inputs received from a user or operator of the client device 202 are in turn transmitted back to server 206 and are used to control execution of the software application that is running on the server 206.

So for example, in a typical e-commerce shopping environment, a client software application (for example a merchant client interface application or an e-commerce client software application) is installed and run on a client terminal 202—and is configured for network based integration or coupling with an e-commerce server 206. The e-commerce client software application is run on the client terminal 202 and e-commerce data is transmitted from e-commerce server 206 to the client device 202, where it is rendered for display. An online shopper who is operating client device 202 uses the interface controls of client device 202 to provide inputs—which are transmitted back to the e-commerce server 202 and is used as inputs for browsing e-commerce offerings and for making purchases or otherwise interacting with the e-commerce platform.

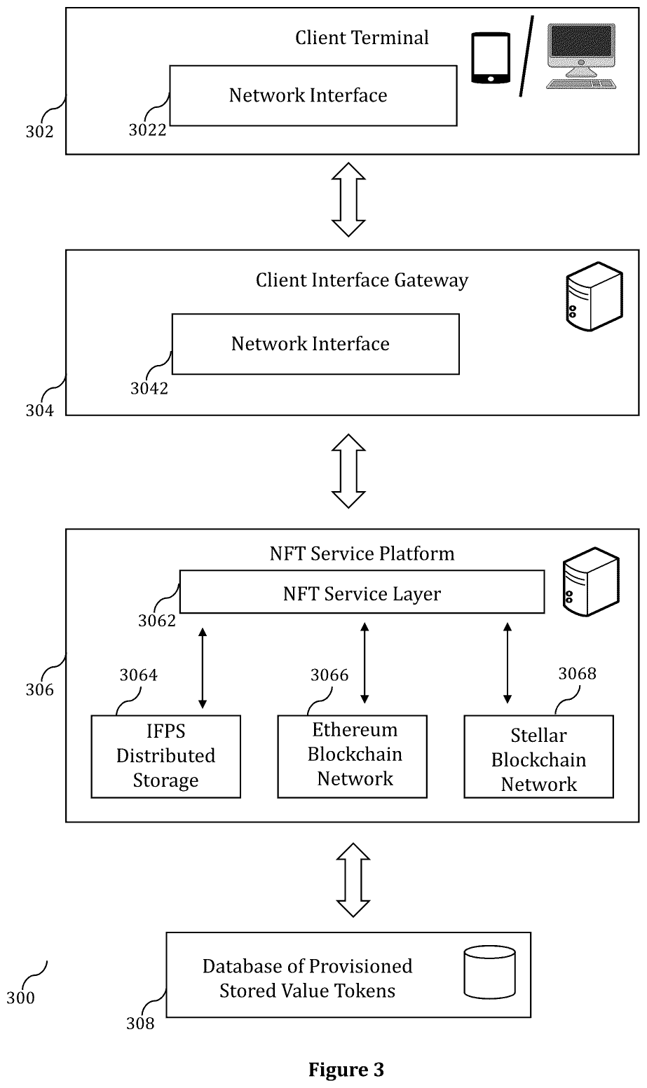

FIG. 3 illustrates an exemplary configuration for a system 300 configured to enable generating, provisioning or transferring non-fungible tokens through a stored value token, in accordance with the teachings of the present invention.

As shown in FIG. 3, system 300 may comprise a client terminal 302, a client interface gateway 304, an NFT service platform 306, and a database of provisioned stored value tokens 308.

Client terminal 302 may comprise any processor based client device or terminal through which a user is enabled for network based communications, and/or network access or internet access. Client terminal 302 may include a network interface 3022 configured for network communication capability. In various examples, client terminal 302 may include any of a laptop, desktop, mobile device or set top box that is configured to interface through a communication network such as a data network or the internet, with any other network communication enabled device—including for example, client interface gateway 304. In various embodiments, network interface 3022 may comprise an interface provided by a client interface gateway software application or by a web browser based interface implemented within client terminal 302.

Client interface gateway 304 may comprise any processor based gateway server(s) configured to function as a gateway interface or as a network intermediary between client terminal 302 and NFT service platform 306.

NFT service platform 306 comprises a server implemented platform that is communicably coupled with, or that is in network communication with, client interface gateway 304. NFT services platform 306 is/configured to enable non-fungible tokens that are generated or provisioned pursuant to the methods of the present invention to be published to and saved on a blockchain infrastructure comprising at least one distributed blockchain ledger. As illustrated in FIG. 3, NFT service platform 306 may comprise NFT service layer 3062—comprising a processor implemented software interface that enables client interface gateway 304 (and/or client terminal 302) to communicate with NFT service platform 3062 for the purposes of generating, provisioning saving retrieving or otherwise accessing non-fungible tokens that are linked to stored value tokens in accordance with the teachings of the present invention. The NFT service layer 3062 may be configured to communicate with one or more blockchain networks or elements of blockchain infrastructure including without limitation any of the InterPlanetary File System (IFPS) distributed storage system 3064, the Ethereum blockchain network 3066, the Stellar Blockchain network 3068 or any other blockchain network or blockchain data storage system. Non-fungible tokens generated or provisioned in accordance with the teachings of the present invention may be stored within a blockchain within the blockchain infrastructure by NFT service layer 3062 interacting with any such blockchain networks or elements of blockchain infrastructure. In an embodiment, the elements of blockchain infrastructure may include a distributed blockchain ledger.

NFT service platform 308 is configured for network communication with a database of provisioned stored value tokens 308. The database 308 is a database configured to store information about stored value tokens that are associated with or linked to a non-fungible token, or with an entitlement to receive a non-fungible token. By accessing the database 308, NFT service platform 308 can determine whether a stored value token that has been presented or received at NFT service platform 308 is linked to a non-fungible token, or with an entitlement to receive a non-fungible token, and if so, can initiate steps for provisioning or generating or assigning a non-fungible token to a beneficiary of the stored value token.

The system 300 of FIG. 3 may be used to implement any of the methods described subsequently in this written description.

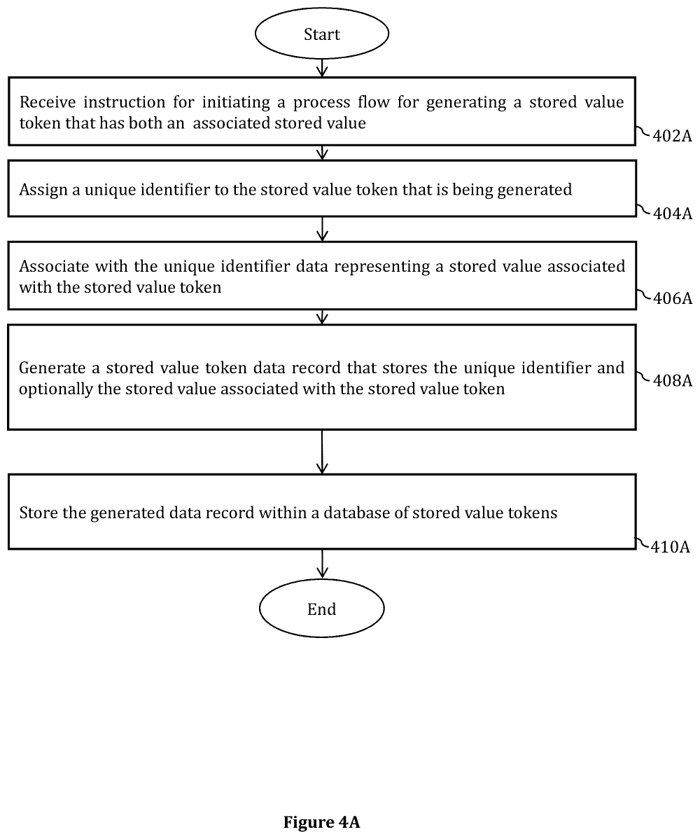

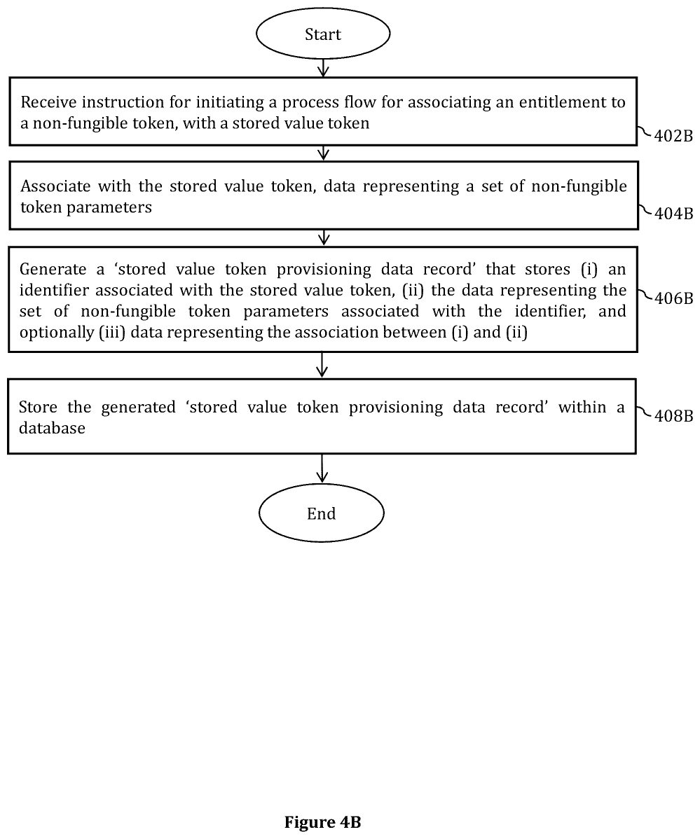

FIG. 4A is a flowchart illustrating method steps involved in generating a stored value token that has an associated stored value. The method of FIG. 4A may be implemented by any entity that generates, issues, retails or distributes stored value tokens. For example, the method of FIG. 4A may be implemented by an issuer, distributor or retailer of pre-paid currency cards, phone cards, gift cards, or scratch card. In a more particular embodiment, the method of FIG. 4A may be implemented at a server configured to implement the method steps of FIG. 4A.

Step 402A comprises receiving an instruction for initiating a process flow for generating a stored value token that has an associated stored value. The instruction may be received at a server configured to implement the method steps of FIG. 4A. In an embodiment, the instruction may be the result of a user input or an operator input or a software application generated input received at the server.

Step 404A comprises assigning a unique identifier to the stored value token that is being generated. In an embodiment, the assigned unique identifier is a unique numeric or alpha-numeric character string associated with the stored value token or with a stored value account corresponding to the stored value token.

Step 406A comprises associating with the unique identifier, data representing a stored value associated with the stored value token.

Step 408A comprises generating a stored value token data record that stores (i) the unique identifier that has been assigned to the stored value token, and optionally (ii) the data representing a stored value associated with the stored value token and optionally (iii) the association between (i) and (ii).

In an embodiment, step 410A may comprise retrievably storing the stored value token data record within a database of stored value tokens (e.g. in database 308).

By implementing the method steps of FIG. 4A, the server implementing such method generates a stored value token of a kind that may be used for the purposes of the present invention.

FIG. 4B is a flowchart illustrating method steps involved in associating an entitlement to a non-fungible token, with a stored value token. The stored value token may comprise a stored value token that has been generated in accordance with the method of FIG. 4B. In an embodiment the method steps of FIG. 4B may be implemented simultaneously with the method steps of FIG. 4A at the time of generation of the stored value token. In other embodiments, the method steps of FIG. 4B may be implemented subsequent to generation of the stored value token. The method steps of FIG. 4B may be implemented by the same entity that generates the stored value token, or by any other distinct entity. In an embodiment, the method of FIG. 4B may be implemented by any entity that generates, issues, retails or distributes stored value tokens, Including any of an issuer, distributor or retailer of pre-paid currency cards, phone cards, gift cards, or scratch card. In a more particular embodiment, the method of FIG. 4B may be implemented at a server configured to implement the method steps of FIG. 4B.

Step 402B comprises receiving an instruction for initiating a process flow for associating an entitlement to a non-fungible token, with a stored value token. The instruction may be received at a server configured to implement the method steps of FIG. 4B. In an embodiment the instruction may be the result of a user input or an operator input or a software application generated input received at the server.

Step 404B comprises associating with the stored value token (for example, a stored value token generated in accordance with the method of FIG. 4A), data representing a set of non-fungible token parameters to be associated with said stored value tokens. The data representing the set of non-fungible token parameters defines properties or parameters that identify or corresponding to a non-fungible token that is associated with or assigned to the stored value token. The stored value token may be identified based on an identifier corresponding to such stored value token (e.g. a unique identifier corresponding to the stored value token, or alternatively an identifier associated with a class or category of stored value tokens to which the stored value token belongs). Further, the step of associating the non-fungible token parameters with the stored value token may consist of associating the non-fungible token parameters with the above mentioned identifier corresponding to such stored value token.

Step 406B comprises generating a ‘stored value token provisioning data record’ that stores (i) the identifier associated with the stored value token, (ii) the data representing the set of non-fungible token parameters that has been associated with the identifier, and optionally (iii) data representing the association between (i) and (ii).

At step 408B, the generated ‘stored value token provisioning data record’ may be retrievably stored within a database (e.g. a database of stored value token provisioning data records, and in a specific embodiment, database 308).

By implementing the method steps of FIG. 4B, the server implementing the method provisions a stored value token such that such stored value token now has both an associated stored value, and an associated entitlement to a non-fungible token.

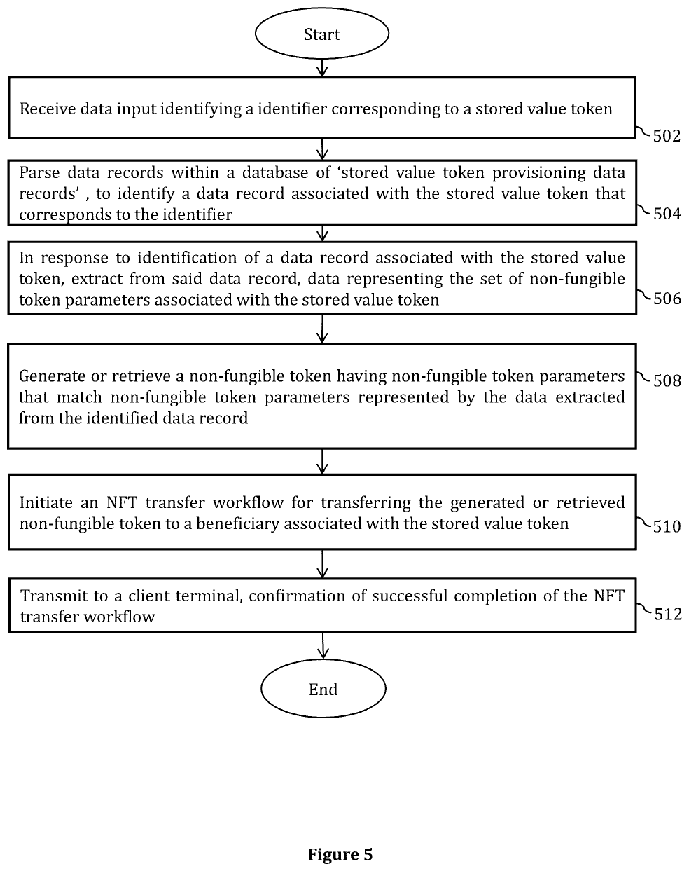

FIG. 5 is a flowchart illustrating method steps involved in generating, provisioning or transferring non-fungible tokens through a stored value token, in accordance with the teachings of the present invention. In an embodiment, the method of FIG. 5 enables obtaining of a non-fungible token based on acquisition of a stored value token. The method of FIG. 5 may be implemented at NFT service platform 306 (as illustrated in FIG. 3).

Step 502 comprises receiving a data input identifying an identifier corresponding to a stored value token. The identifier may comprise a unique identifier corresponding to the stored value token. The data input identifying a unique identifier corresponding to a stored value token may be received as a result of a process flow initiated by an owner or beneficiary of a stored value token, (i) for retrieving or obtaining the non-fungible token that has been associated with the stored value token, or (ii) for redeeming or transferring the entitlement to receive a non-fungible token that has been associated with the stored value token. In an embodiment, the data input may arise as a result of a user input for retrieving or obtaining a non-fungible token that has been associated with a stored value token, wherein the user input has been provided at client terminal 302 and has been transmitted to NFT service platform 306 either directly or through client interface gateway 304. In another embodiment, the data input may be transmitted to NFT service platform 306 either directly or through client interface gateway 304 by a server implementing the method of FIG. 4, subsequent to implementation of method step 410.

Step 504 comprises parsing data records within the database of ‘stored value token provisioning data records’ 308, to identify a data record associated with the stored value token that corresponds to the identifier. The parsing of data records at step 504 is implemented to ascertain whether the stored value token which corresponds to the received identifier has a non-fungible token or an entitlement to a non-fungible token that has been associated therewith. Since each of the ‘stored value token provisioning data records’ is a data record representing a stored value token that has a non-fungible token or an entitlement to a non-fungible token associated therewith, identification of a data record associated with the stored value token that corresponds to the identifier within the database of ‘stored value token provisioning data records’ may be treated as a positive determination that the stored value token which corresponds to the received identifier has a non-fungible token or an entitlement to a non-fungible token that has been associated therewith.

Step 506 comprises responding to identification within the ‘stored value token provisioning data records’ 308, of a data record that is associated with the stored value token that corresponds to the identifier, by extracting from said data record, data representing a set of non-fungible token parameters associated with the stored value token. In an embodiment the extracted data representing the set of non-fungible token parameters includes (i) data representing an address at which the non-fungible token that is associated with the stored value token, is available for retrieval, or (ii) a unique identifier which enables retrieval of the non-fungible token that is associated with the stored value token, or (iii) data representing content or rights associated with the non-fungible token that is associated with the stored value token.

Step 508 comprises generating or retrieving a non-fungible token having non-fungible token parameters that match non-fungible token parameters represented by the data extracted from the identified data record. In an embodiment where the extracted data at step 506 comprises data representing an address at which the non-fungible token that is associated with the stored value token, is available for retrieval, step 508 comprises retrieving the non-fungible token stored at the represented address. In an embodiment where the extracted data at step 506 comprises data representing a unique identifier which enables retrieval of the non-fungible token that is associated with the stored value token, step 508 comprises locating and retrieving the non-fungible token from a database of stored non-fungible tokens based on the unique identifier which enables retrieval of the non-fungible token that is associated with the stored value token.

In an embodiment where the extracted data at step 506 comprises data representing content or rights associated with the non-fungible token that is associated with the stored value token, step 508 comprises generating and storing a non-fungible token having the represented content or rights. In this embodiment where a non-fungible token is generated having the content or rights represented by data extracted at step 506, the step of generating the non-fungible token comprises (i) generating a non-fungible token record representing the non-fungible token, wherein the non-fungible token record includes data identifying or representing said content (for example media content) or rights—which data is recorded within the non-fungible token, and (ii) implementing recordal of the non-fungible token on a distributed blockchain ledger, wherein implementing the recordal comprises (a) transmitting the non-fungible token record to a non-fungible token services platform, and (b) storing data from the non-fungible token record in a record block associated with the distributed blockchain ledger.

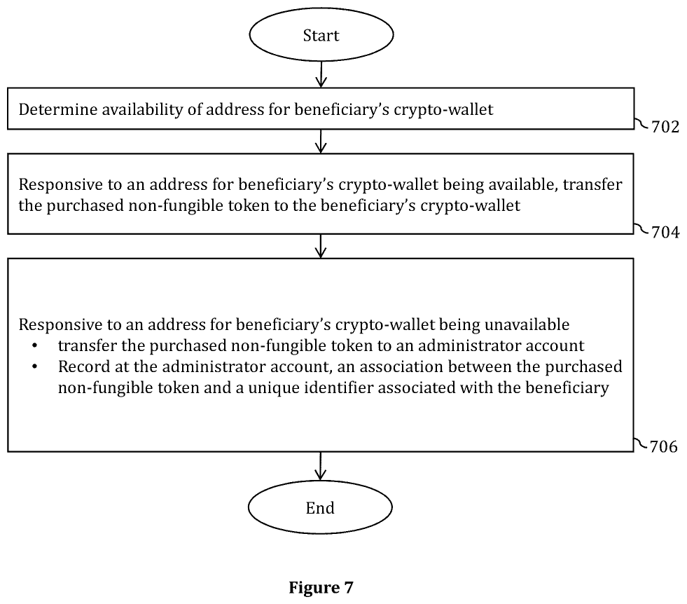

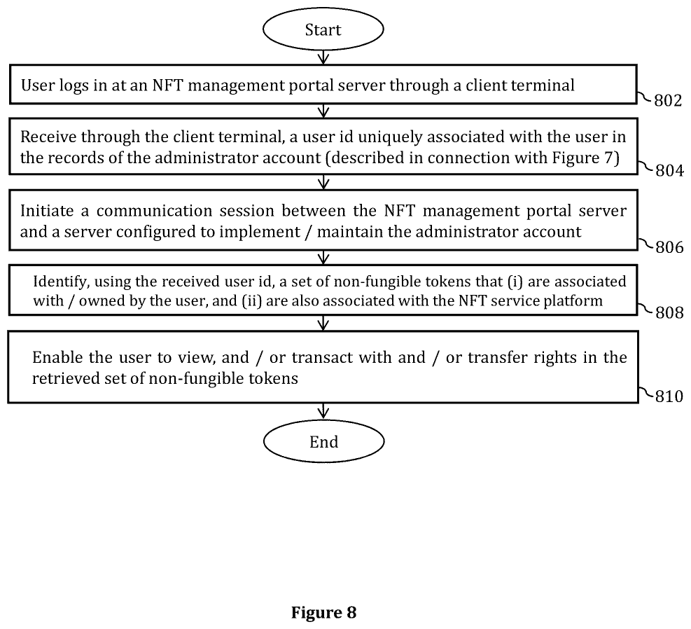

Step 510 comprises initiating an NFT transfer workflow for transferring the generated or retrieved non-fungible token to a beneficiary or recipient or owner or assignee of the stored value token. The NFT transfer workflow is described in more detail below in connection with the method of FIG. 7.

Step 512 comprises transmitting to a client terminal (or to an electronic user account or electronic address) that is accessible by a beneficiary or recipient or owner or assignee of the stored value token, confirmation of successful completion of the NFT transfer workflow.

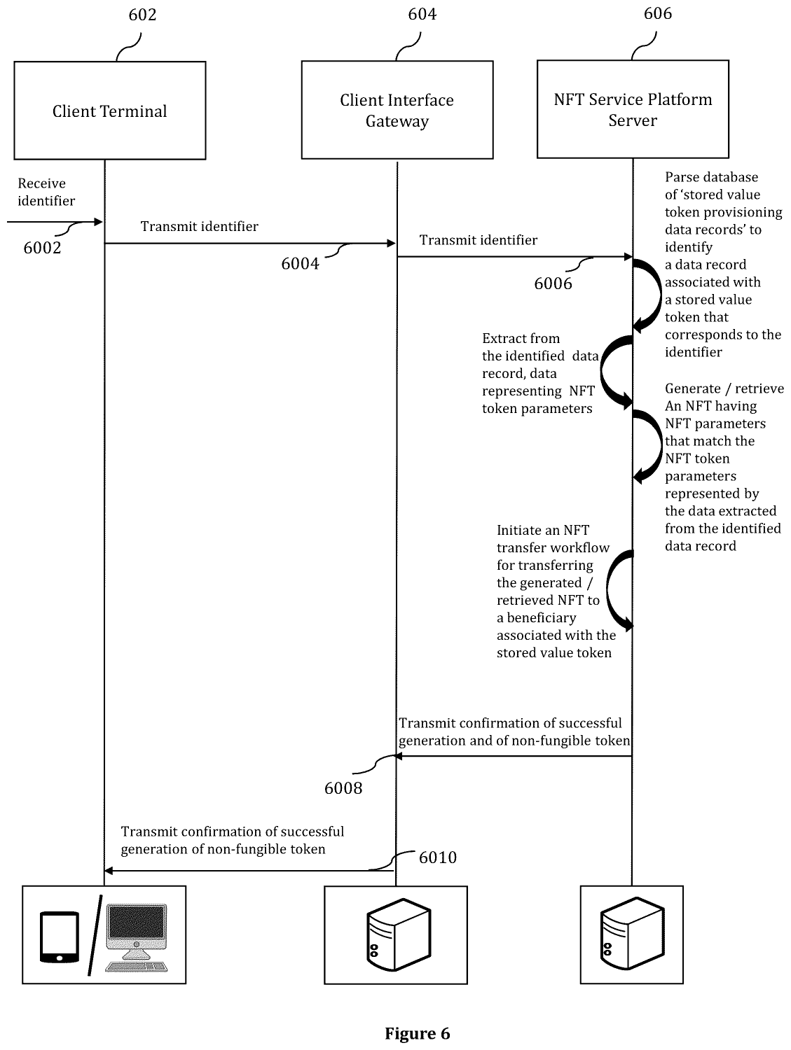

FIG. 6 is a communication flow diagram illustrating an exemplary communication flow between system entities for implementing the method of FIG. 5.

Step 6002 comprises receiving at client terminal 602, an identifier corresponding to a stored value token. The identifier corresponding to the stored value token may have been received at client terminal 602 by way of a user data input identifying an identifier corresponding to a stored value token, within a process flow initiated by an owner or beneficiary of a stored value token, (i) for retrieving or obtaining the non-fungible token that has been associated with the stored value token, or (ii) for redeeming or transferring the entitlement to receive a non-fungible token that has been associated with the stored value token.

Step 6004 comprises transmitting the identifier from the client terminal 602 to a client interface gateway 604, and step 6004 comprises transmitting the identifier from the client interface gateway 604 to NFT Service Platform Server 606.

NFT Service Platform Server 606 thereafter parses data records within a database of ‘stored value token provisioning data records’ (e.g. within database 308) 308, to identify a data record associated with the stored value token that corresponds to the identifier. The parsing of data records is implemented to ascertain whether the stored value token which corresponds to the received identifier has a non-fungible token or an entitlement to a non-fungible token that has been associated therewith. Since each of the ‘stored value token provisioning data records’ is a data record representing a stored value token that has a non-fungible token or an entitlement to a non-fungible token associated therewith, identification of a data record associated with the stored value token that corresponds to the identifier within the database of ‘stored value token provisioning data records’ may be treated as a positive determination that the stored value token which corresponds to the received identifier has a non-fungible token or an entitlement to a non-fungible token that has been associated therewith.

In response to responding to identification of a data record having a data field that matches the unique identifier, NFT Service Platform Server 606 extracts data representing the set of non-fungible token parameters associated with the unique identifier from the identified data record. In an embodiment the extracted data representing the set of non-fungible token parameters includes (i) data representing an address at which the non-fungible token that is associated with the stored value token, is available for retrieval, or (ii) a unique identifier which enables retrieval of the non-fungible token that is associated with the stored value token, or (iii) data representing content or rights associated with the non-fungible token that is associated with the stored value token.

NFT Service Platform Server 606 subsequently generates or retrieves a non-fungible token having non-fungible token parameters that match non-fungible token parameters represented by the data extracted from the identified data record. In an embodiment where the extracted data comprises data representing an address at which the non-fungible token that is associated with the stored value token, is available for retrieval, NFT Service Platform Server 606 retrieves the non-fungible token stored at the represented address. In an embodiment where the extracted data comprises data representing a unique identifier which enables retrieval of the non-fungible token that is associated with the stored value token, NFT Service Platform Server 606 locates and retrieves the non-fungible token from a database of stored non-fungible tokens based on the unique identifier which enables retrieval of the non-fungible token that is associated with the stored value token. In an embodiment where the extracted data comprises data representing content or rights associated with the non-fungible token that is associated with the stored value token, NFT Service Platform Server 606 comprises generates and stores a non-fungible token having the represented content or rights.

NFT Service Platform Server 606 thereafter initiates an NFT transfer workflow for transferring the generated or retrieved non-fungible token to a beneficiary or recipient or owner or assignee of the stored value token. The NFT transfer workflow is described in more detail below in connection with the method of FIG. 7. The NFT transfer workflow includes selectively transferring the generated or retrieved non-fungible token to (i) a crypto-wallet associated with, operated by, controlled by, or specified by the beneficiary or recipient or owner or assignee of the stored value token, or (ii) an administrator account maintained by NFT Service Platform 306. Additionally, in response to transfer of the generated or retrieved non-fungible token to a crypto-wallet associated with, or operated by, or controlled by, or specified by the beneficiary (e.g. the recipient or owner or assignee) of the stored value token, data representing the transfer of ownership (or ownership rights) in the non-fungible token to the beneficiary is recorded to the distributed blockchain ledger (within the blockchain infrastructure) on which the transferred non-fungible token is stored—wherein said storage is implemented in a manner that that data representing the transfer of ownership (or ownership rights) in the non-fungible token is associated with the stored non-fungible token.

Step 6008 comprises transmitting from NFT Service Platform Server 606 to client interface gateway 604, confirmation of successful completion of the NFT transfer workflow. At step 6010, client interface gateway 604 transmits to client terminal 602, the confirmation of successful completion of the NFT transfer workflow.

FIG. 7 is a flowchart illustrating method steps involved in assigning or provisioning to a beneficiary of a stored value token, a non-fungible token corresponding to an entitlement to a non-fungible token that is associated with the stored value token. In an embodiment the method of FIG. 7 may be implemented within step 510 of the method of FIG. 5. In an embodiment, the method of FIG. 7 may be implemented within an NFT Services Platform 306.

Step 702 of the method of FIG. 7 comprises determining availability of an address for crypto-wallet of a beneficiary or intended owner of a non-fungible token(s)—i.e. the beneficiary/owner of the stored value token with which the non-fungible token is associated.

Responsive to an address for a beneficiary's or intended owner's crypto-wallet being available—step 704 comprises transferring the non-fungible token associated with the stored value token to the beneficiary's or intended owner's crypto-wallet.

In an embodiment, in the event the stored value token has an entitlement to a non-fungible token associated therewith (instead of having a non-fungible token itself associated therewith), the transfer of the non-fungible token at step 704 may be preceded by the step of generating a non-fungible token corresponding to said entitlement. In this embodiment, the step of generating the non-fungible token comprises (i) generating a non-fungible token record representing the non-fungible token, wherein the non-fungible token record includes data identifying or representing content (for example media content) or rights corresponding to said entitlement—and this data is recorded within the non-fungible token, and (ii) implementing recordal of the non-fungible token on a distributed blockchain ledger, wherein implementing the recordal comprises (a) transmitting the non-fungible token record to a non-fungible token services platform, and (b) storing data from the non-fungible token record in a record block associated with the distributed blockchain ledger.

Additionally at step 704, in response to transfer of the generated or retrieved non-fungible token to the beneficiary's or intended owner's crypto-wallet, data representing the transfer of ownership (or ownership rights) in the non-fungible token to the beneficiary/intended owner is recorded to the distributed blockchain ledger (within the blockchain infrastructure) on which the transferred non-fungible token is stored—wherein said storage is implemented in a manner that that data representing the transfer of ownership (or ownership rights) in the non-fungible token is associated with the stored non-fungible token.

Responsive to an address for the beneficiary's or intended owner's crypto-wallet being unavailable, step 706 comprises:
transferring the purchased non-fungible token(s) to an administrator account maintained by the NFT Services Platform 306 (or by any other administrator entity), and
recording at the NFT Services Platform 306 or at the administrator account, an association between the non-fungible token(s) and a unique identifier associated with the beneficiary or intended owner—such that the purchased non-fungible token(s) can be later transferred to a crypto-wallet that is owned or controlled by the beneficiary or intended owner, and wherein said crypto-wallet is also associated with the unique identifier that is associated with the purchaser.

The method of FIG. 7 provides a significant advantage inasmuch that it enables the methods of FIG. 5, when a beneficiary or intended owner of a non-fungible token that is associated with a stored value token does not have a crypto-wallet account to store the purchased non-fungible token. By enabling a beneficiary or intended owner to store a non-fungible token in a cloud services server or an administrator account, along with an identifier associating the non-fungible token with the beneficiary or intended owner, the method of FIG. 7 enables redemption of a non-fungible token associated with a stored value token, in favor or the beneficiary or intended owner, and for such person or entity to subsequently transfer or trade the non-fungible token without requiring a crypto-wallet account.

FIG. 8 is a flowchart illustrating method steps involved in access and management of non-fungible tokens (that have been generated and stored as a consequence of the method of FIG. 7) through a non-fungible token management portal. In an embodiment, the non-fungible token management portal may be implemented at or through a NFT management portal server. In an embodiment, the NFT management portal server may be implemented within or may comprise a part of NFT Services Platform 306 of FIG. 3.

At step 802, a user logs in to the NFT management portal server through a client terminal 302.

Step 804 comprises receiving byway of user input through client terminal 302, a user id. The received user id comprises an identifier uniquely associated with the user in the records of the administrator account to which NFT Services Platform 306 is configured to transfer non-fungible tokens in accordance with the method of FIG. 7.

Step 806 comprises initiating a communication session between the NFT management portal server and a server configured to implement/maintain the administrator account.

Step 808 comprises identifying, using or based on the received user id, a set of non-fungible tokens that are associated with or owned by the user, and which are stored in the administrator account. In an embodiment step 808 may comprise identifying from a database of non-fungible tokens stored in the administrator account, one or more non-fungible tokens that are associated with or linked to the received user id.

Step 810 comprises enabling the user to view, and/or transact with and/or transfer rights in the retrieved set of non-fungible tokens at the NFT management portal server through the client terminal 302. In the event of a transaction relating to, or transfer of rights in the retrieved set of non-fungible tokens, data representing the transaction or transfer of ownership (or ownership rights) in the non-fungible token(s) (including data identifying the beneficiary/assignee/intended owner) is recorded to the distributed blockchain ledger (within the blockchain infrastructure) on which the transferred non-fungible token(s) are stored—wherein said storage is implemented in a manner that that data representing the transaction or transfer of ownership (or ownership rights) in the non-fungible token(s) is associated with the stored non-fungible token(s).

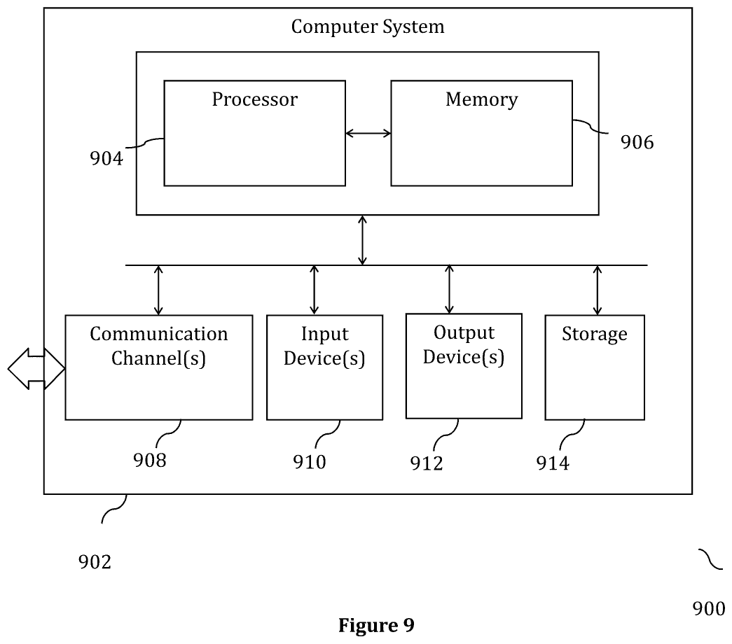

FIG. 9 illustrates an exemplary system 900 for implementing the present invention. The illustrated system 900 comprises computer system 902 which in turn comprises one or more processors 904 and at least one memory 906. Processor 904 is configured to execute program instructions—and may be a real processor or a virtual processor. It will be understood that computer system 902 does not suggest any limitation as to scope of use or functionality of described embodiments. The computer system 902 may include, but is not be limited to, one or more of a general-purpose computer, a programmed microprocessor, a micro-controller, an integrated circuit, and other devices or arrangements of devices that are capable of implementing the steps that constitute the method of the present invention. Exemplary embodiments of a computer system 902 in accordance with the present invention may include one or more servers, desktops, laptops, tablets, smart phones, mobile phones, mobile communication devices, tablets, phablets and personal digital assistants. In an embodiment of the present invention, the memory 906 may store software for implementing various embodiments of the present invention. The computer system 902 may have additional components. For example, the computer system 902 may include one or more communication channels 908, one or more input devices 910, one or more output devices 912, and storage 914. An interconnection mechanism (not shown) such as a bus, controller, or network, interconnects the components of the computer system 902. In various embodiments of the present invention, operating system software (not shown) provides an operating environment for various softwares executing in the computer system 902 using a processor 904, and manages different functionalities of the components of the computer system 902.

The communication channel(s) 908 allow communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth or other transmission media.

The input device(s) 910 may include, but is not limited to, a touch screen, a keyboard, mouse, pen, joystick, trackball, a voice device, a scanning device, or any another device that is capable of providing input to the computer system 902. In an embodiment of the present invention, the input device(s) 910 may be a sound card or similar device that accepts audio input in analog or digital form. The output device(s) 912 may include, but not be limited to, a user interface on CRT, LCD, LED display, or any other display associated with any of servers, desktops, laptops, tablets, smart phones, mobile phones, mobile communication devices, tablets, phablets and personal digital assistants, printer, speaker, CD/DVD writer, or any other device that provides output from the computer system 902.

The storage 914 may include, but not be limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 902. In various embodiments of the present invention, the storage 914 may contain program instructions for implementing any of the described embodiments.

In an embodiment of the present invention, the computer system 902 is part of a distributed network or a part of a set of available cloud resources.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 902. The method described herein is typically implemented as a computer program product, comprising a set of program instructions that is executed by the computer system 902 or any other similar device. The set of program instructions may be a series of computer readable codes stored on a tangible medium, such as a computer readable storage medium (storage 914), for example, diskette, CD-ROM, ROM, flash drives or hard disk, or transmittable to the computer system 902, via a modem or other interface device, over either a tangible medium, including but not limited to optical or analogue communications channel(s) 908. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

The invention accordingly provides solutions for generating, provisioning or transferring non-fungible tokens through a stored value token that has an associated stored value, and that additionally has an associated entitlement to a non-fungible token (which non-fungible token is unrelated to or distinct from the stored value). The invention additionally enables an entitlement to a non-fungible token that is associated with a stored value token to be claimed, resulting in a non-fungible token being generated, provisioned or transferred to a beneficiary of the stored value token.

While the exemplary embodiments of the present invention are described and illustrated herein, it will be appreciated that they are merely illustrative. It will be understood by those skilled in the art that various modifications in form and detail may be made therein without departing from or offending the scope of the invention as defined by the appended claims. Additionally, the invention illustratively disclose herein suitably may be practiced in the absence of any element which is not specifically disclosed herein—and in a particular embodiment specifically contemplated, is intended to be practiced in the absence of any element which is not specifically disclosed herein.

We claim:

1. A method for obtaining to a beneficiary, rights in a non-fungible token (NFT) that is recorded within a distributed blockchain ledger, based on acquisition of a stored value token, the method comprising implementing at a NFT service platform server, the steps of:
receiving a data input transmitted from a client terminal, wherein the data input identifies a unique identifier corresponding to a stored value token;
identifying within a database of stored value token data records, a data record associated with the stored value token that corresponds to the unique identifier;
extracting from the identified data record, data representing a set of non-fungible token parameters associated with the stored value token;
generating or retrieving a NFT having one or more non-fungible token parameters that match non-fungible token parameters represented by the data extracted from the identified data record;
initiating a NFT transfer process for transferring rights in the NFT to an identified beneficiary, wherein:
the NFT transfer process includes selectively transferring the NFT to one of:
a crypto-wallet associated with the identified beneficiary; and
an administrator account;
responsive to transfer of the NFT to the crypto-wallet associated with the identified beneficiary, recording data representing the identified beneficiary's right(s) in the NFT in a record block within a distributed blockchain ledger on which the NFT is stored.

2. The method as claimed in claim 1, wherein the NFT transfer process comprises:
responding to a determination that a crypto-wallet address of the identified beneficiary is available, by transferring the NFT to a crypto-wallet identified by the crypto-wallet address.

3. The method as claimed in claim 1, wherein the NFT transfer process comprises:
responding to a determination that a crypto-wallet address of the identified beneficiary is unavailable, by:
transferring the NFT to the administrator account; and
recording at the administrator account, an association between the NFT and a unique identifier associated with the identified beneficiary.

4. The method as claimed in claim 3, further comprising:
identifying based on a received user id, a set of NFTs stored in the administrator account, wherein the received user id comprises an identifier uniquely associated with the beneficiary in the records of the administrator account;
transferring one or more NFTs within the identified set of NFTs from the beneficiary to a transferee crypto-wallet associated with a specified transferee; and
responsive to transfer of the one or more NFTs to the transferee crypto-wallet, recording data representing the transferee's right(s) in the transferred one or more NFTs in one or more record block within a distributed blockchain ledger on which said one or more NFTs are stored.

5. The method as claimed in claim 1, wherein the stored value token comprises any physical token or electronic token or virtual token that has one or more unique identifier(s) associated therewith, and that has a stored value account linked thereto, wherein said stored value account is configured to enable recordal or storage of any of currency value, rewards points, or gift coupon points.

6. The method as claimed in claim 1, wherein the identified beneficiary:
is an entity that is associated with the stored value token, or that has ownership or possession of the stored value token; or
has been identified based on a data instruction received from an entity that is associated with the stored value token, or that has ownership or possession of the stored value token;

7. The method as claimed in claim 1, wherein the data representing the identified beneficiary's right(s) in the NFT in the record block within the distributed blockchain ledger on which the NFT is stored, is associated with the stored NFT.

8. A system configured for obtaining to a beneficiary, rights in a non-fungible token (NFT) that is recorded within a distributed blockchain ledger, based on acquisition of a stored value token, the system comprising a processor implemented NFT service platform server configured to implement the steps of:
receiving a data input transmitted from a client terminal, wherein the data input identifies a unique identifier corresponding to a stored value token;
identifying within a database of stored value token data records, a data record associated with the stored value token that corresponds to the unique identifier;
extracting from the identified data record, data representing a set of non-fungible token parameters associated with the stored value token;
generating or retrieving a NFT having one or more non-fungible token parameters that match non-fungible token parameters represented by the data extracted from the identified data record;
initiating a NFT transfer process for transferring rights in the NFT to an identified beneficiary, wherein:
the NFT transfer process includes selectively transferring the NFT to one of:
a crypto-wallet associated with the identified beneficiary; and
an administrator account;
responsive to transfer of the NFT to the crypto-wallet associated with the identified beneficiary, recording data representing the identified beneficiary's right(s) in the NFT in a record block within a distributed blockchain ledger on which the NFT is stored.

9. The system as claimed in claim 8, configured such that implementing the NFT transfer process comprises:
responding to a determination that a crypto-wallet address of the identified beneficiary is available, by transferring the NFT to a crypto-wallet identified by the crypto-wallet address.

10. The system as claimed in claim 8, configured such that implementing the NFT transfer process comprises:
responding to a determination that a crypto-wallet address of the identified beneficiary is unavailable, by:
transferring the NFT to the administrator account; and
recording at the administrator account, an association between the NFT and a unique identifier associated with the identified beneficiary.

11. The system as claimed in claim 10, further configured for:
identifying based on a received user id, a set of NFTs stored in the administrator account, wherein the received user id comprises an identifier uniquely associated with the beneficiary in the records of the administrator account;
transferring one or more NFTs within the identified set of NFTs from the beneficiary to a transferee crypto-wallet associated with a specified transferee; and
responsive to transfer of the one or more NFTs to the transferee crypto-wallet, recording data representing the transferee's right(s) in the transferred one or more NFTs in one or more record block within a distributed blockchain ledger on which said one or more NFTs are stored.

12. The system as claimed in claim 8, wherein the stored value token comprises any physical token or electronic token or virtual token that has one or more unique identifier(s) associated therewith, and that has a stored value account linked thereto, wherein said stored value account is configured to enable recordal or storage of any of currency value, rewards points, or gift coupon points.

13. The system as claimed in claim 8, wherein the identified beneficiary:
is an entity that is associated with the stored value token, or that has ownership or possession of the stored value token; or
has been identified based on a data instruction received from an entity that is associated with the stored value token, or that has ownership or possession of the stored value token;

14. The system as claimed in claim 8, wherein the data representing the identified beneficiary's right(s) in the NFT in the record block within the distributed blockchain ledger on which the NFT is stored, is associated with the stored NFT.

15. A computer program product for obtaining to a beneficiary, rights in a non-fungible token (NFT) that is recorded within a distributed blockchain ledger, based on acquisition of a stored value token, the computer program product comprising a non-transitory computer readable medium having a computer readable program code embodied therein, the computer readable program code comprising instructions for implementing the steps of:
receiving a data input transmitted from a client terminal, wherein the data input identifies a unique identifier corresponding to a stored value token;
identifying within a database of stored value token data records, a data record associated with the stored value token that corresponds to the unique identifier;
extracting from the identified data record, data representing a set of non-fungible token parameters associated with the stored value token;
generating or retrieving a NFT having one or more non-fungible token parameters that match non-fungible token parameters represented by the data extracted from the identified data record;
initiating a NFT transfer process for transferring rights in the NFT to an identified beneficiary, wherein:
the NFT transfer process includes selectively transferring the NFT to one of:
a crypto-wallet associated with the identified beneficiary; and
an administrator account;
responsive to transfer of the NFT to the crypto-wallet associated with the identified beneficiary, recording data representing the identified beneficiary's right(s) in the NFT in a record block within a distributed blockchain ledger on which the NFT is stored.
